(19) United States
(12) Patent Application Publication
(10) Pub. No.: US 2008/0130704 A1
(43) Pub. Date: Jun. 5, 2008

(54) Electroslag smelting system and method

(76) Inventors: Albert E. LaPoint, Hermosa Beach, CA (US); Brian A. LaPoint, Hermosa Beach, CA (US)

Correspondence Address: Cislo & Thomas LLP, 1333 2nd Street, Suite #500, Santa Monica, CA, 90401-4110, US

(21) Appl. No.: 11/981,328

(22) Filed: Oct. 31, 2007

Related U.S. Application Data
(60) Provisional application No. 60/872,016, filed on Nov. 30, 2006.

(51) Int. Cl. H05B 3/60; C22B 4/00; C22B 4/08

(52) U.S. Cl. 373/55; 75/10.62

(57) ABSTRACT

A system and a method for electroslag smelting, involving a furnace having a wall, an internal atmosphere, and an external atmosphere; a trough for accommodating an ore being smelted into a molten metal and a slag, the trough being disposed within the furnace; and a carbon electrode having a proximal end and a distal end, the electrode distal end being disposed in the trough, the electrode being submersible in the molten metal, and the electrode being separated from the slag by a ceramic barrier.

### CROSS-REFERENCE TO RELATED APPLICATION(S)

This document is a non-provisional patent application, which is related to, and claims priority from, U.S. Provisional Patent Application Ser. No. 60/872,016, also entitled “Improved Electroslag Smelting System and Method,” filed on Nov. 30, 2006, the disclosure of which is hereby incorporated in its entirety by reference.

### TECHNICAL FIELD

The present invention generally technically relates to smelting systems and methods. More particularly, the present invention technically relates to electroslag smelting systems and methods. Even more particularly, the present invention technically relates to improvements in electroslag systems and methods.

### BACKGROUND ART

Conventional electroslag smelting typically employs a slag layer as an electrical resistor through which an electric current is passed to provide a heat source for the actual smelting operation. Such heat source is highly efficient without any substantial outgas or by-product gas, which would otherwise be associated with burning organic fuels.

However, the problems encountered with conventional electroslag smelting include corrosion of the electrodes as well as the exorbitant costs of the electrical equipment required for producing the requisite low voltages and requisite high currents necessary to achieve the very high requisite kilowatt-hours. Thus, a need is seen to exist in the related art for an improved electroslag system and a method.

### DISCLOSURE OF THE INVENTION

In providing a solution to the foregoing and other known problems and disadvantages inherent in the related art, the present invention involves a system for electroslag smelting, generally comprising: a furnace having a wall, an internal atmosphere, and an external atmosphere; a trough for accommodating an ore being smelted into a molten metal and a slag, the trough being disposed within the furnace, and the trough having an outer housing and an inner liner; and a carbon electrode having a proximal end and a distal end, the electrode distal end being disposed in the trough, the electrode being submersible in the molten metal, and the electrode being separated from the slag by a ceramic barrier.

In addition, the present invention involves a method of electroslag smelting, generally comprising the steps of: providing a furnace having a wall, an internal atmosphere, and an external atmosphere; providing a trough for accommodating an ore being smelted into a molten metal and a slag, the trough being disposed within the furnace, and the trough having an outer housing and an inner liner; providing a carbon electrode having a proximal end and a distal end, the electrode distal end being disposed in the trough, the electrode being submersible in the molten metal, and the electrode being separated from the slag by a ceramic barrier; and smelting the ore in the furnace, thereby providing a molten metal and a slag, the electrode being submersed in the molten metal, and the electrode being separated from the slag by the ceramic barrier. The molten metal which is in physical contact with the carbon electrode is not in physical contact with the metal bath, wherein the remaining electrodes are disposed, nor in physical contact with the main collection pool of the reduced metal.

Correspondingly, the present invention also involves a method of fabricating an electroslag smelting system, generally comprising the steps of: providing a furnace having a wall, an internal atmosphere, and an external atmosphere; providing a trough for accommodating an ore being smelted into a molten metal and a slag, the trough being disposed within the furnace, and the trough having an outer housing and an inner liner; providing a carbon electrode having a proximal end and a distal end, the electrode distal end being disposed in the trough, the electrode being submersible in the molten metal, and the electrode being separated from the slag by a ceramic barrier.

Advantages of the present invention include, but are not limited to, minimizing corrosion of the electrodes, minimizing the costs of the electrical equipment required for producing the requisite low voltages and requisite high currents, and effecting a low temperature equilibrium at an electrical source connection. Other features of the present invention are disclosed, or are apparent, in the section entitled “Mode(s) for Carrying-Out the Invention,” disclosed, infra.

### BRIEF DESCRIPTION OF THE DRAWING

For a better understanding of the present invention, reference is made to the below-referenced accompanying Drawing. Reference numbers refer to the same or equivalent parts of the present invention throughout the several figures of the Drawing.

FIG. 1 is a cross-sectional view of an electroslag system, in accordance with the present invention.

FIG. 2 is a perspective view of an electroslag system, in accordance with the present invention.

FIG. 3 is a top view of an electroslag system, in accordance with the present invention.

FIG. 4A is a cross-sectional view of a smelter leg in an electroslag system, in accordance with the present invention.

FIG. 4B is a cross-sectional view of a smelter leg in an electroslag system, in accordance with the present invention.

FIG. 5 is a perspective cut-away view of a smelter leg in an electroslag system, in accordance with the present invention.

FIG. 6 is a partial perspective view of an electroslag system, in accordance with the present invention.

FIG. 7 is a flowchart of a method of electroslag smelting, in accordance with the present invention.

FIG. 8 is a flowchart of a method of fabricating an electroslag smelting system, in accordance with the present invention.

### MODE(S) FOR CARRYING-OUT THE INVENTION

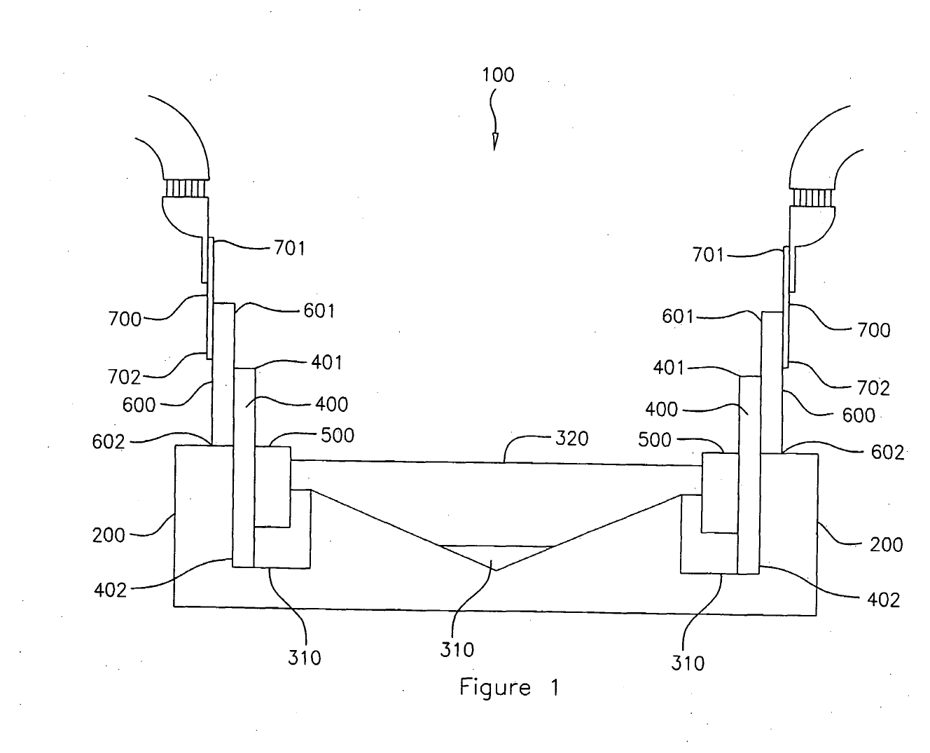

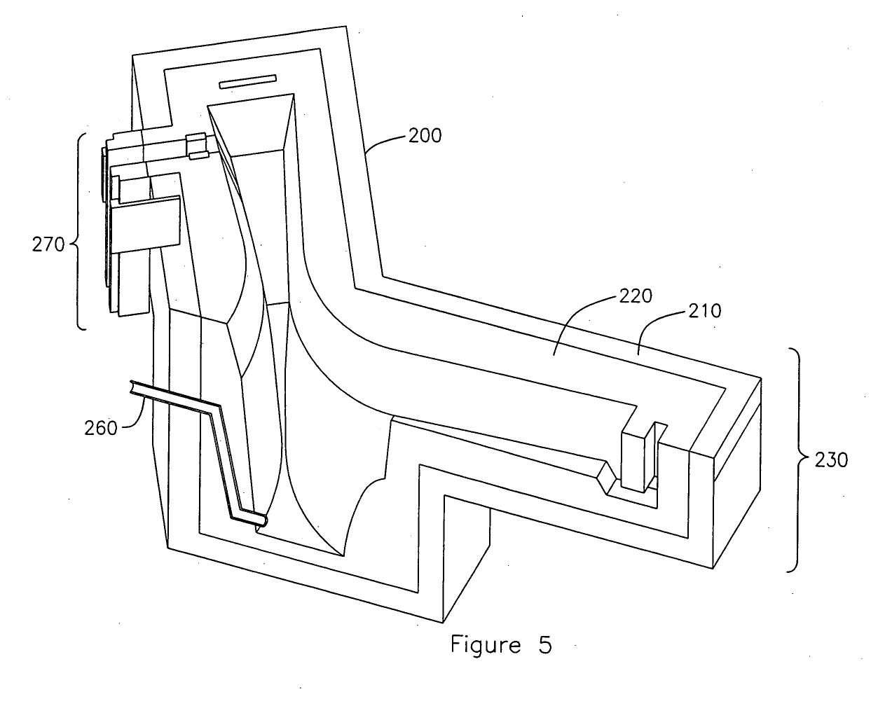

FIG. 1 illustrates, in a cross-sectional view, an electroslag system 100, in accordance with the present invention. The system 100 for electroslag smelting comprises: a furnace (not shown) having a wall, an internal atmosphere, and an external atmosphere; a trough 200 for accommodating an ore 300 being smelted into a molten metal 310 and a slag 320, the trough 200 being disposed within the furnace, and the trough 200 having an outer housing 210 and an inner liner 220 (FIG. 5); and a carbon electrode 400 having a proximal end 401 and a distal end 402, the electrode distal end 402 being disposed in the trough 200, the electrode 400 being submersible in the molten metal 310, and the electrode 400 being separated from the slag 320 by a ceramic barrier 500; a stainless steel bus bar 600 having a proximal end 601 and a distal end 602, the stainless steel bus bar distal end 602 being coupled to the electrode proximal end 401 at a position above a level of the molten metal 310, the stainless steel bus bar proximal end 601 extending through the furnace wall and into the external atmosphere, the stainless steel bus bar 600 providing mechanical stability to the electrode 400, the stainless steel bus bar 600 dissipating heat from the electrode 400, and the stainless steel bus bar 600 nominally conducting heat from the furnace; and a copper bus bar 700 having a proximal end 701 and a distal end 702, the copper bus bar distal end 702 being coupled to the stainless steel bus bar proximal end 601 in the external atmosphere, and the copper bus bar 700 dissipating heat from the stainless steel bus bar 600 at a greater rate than the stainless steel bus bar 600 nominally conducting heat from the furnace, a thermal gradient being effected across the stainless steel bus bar 600, the copper bus bar 700 radiating heat to the external atmosphere at a high rate, a corrosion of the electrode 400 being minimized, and a low temperature equilibrium being effected at an electrical source connection.

Still referring to FIG. 1, the molten metal 310 may comprise lead (Pb). The slag 320 may comprise sodium sulfate (Na₂SO₄). The trough 200 and the ceramic barrier 500 comprise a refractory material. The refractory material may comprise aluminum oxide (Al₂O₃). While the present invention system 100 uses the slag layer 320 as an electrical resistor through which an electric current is passed to provide a heat source for the actual smelting operation, the present invention combination of elements comprising the stainless steel bus bar 600 and the copper bus bar 700 solve the heat transfer problems, inter alia, of the related art. The carbon electrode 400 may comprise a stainless steel foil (not shown) on its outer surfaces.

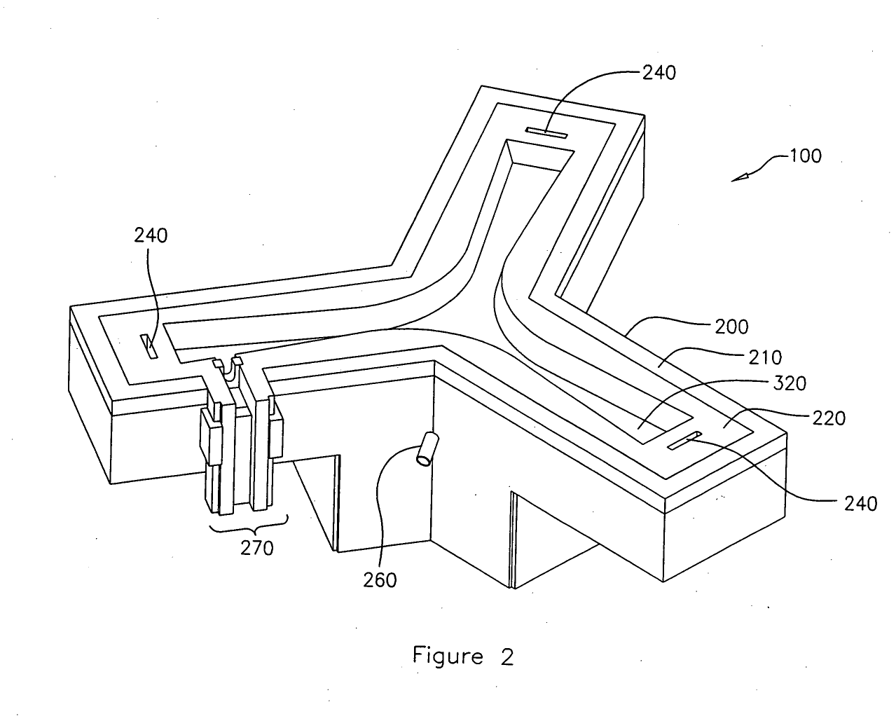

FIG. 2 illustrates, in a perspective view, an electroslag system 100, showing a trough 200 having a molten metal 310, in accordance with the present invention. The trough 200 may comprise a vacuum port 260 for facilitating removal of any residual gases from the molten metal 310 as well as a thermocouple bracket assembly 270 for accommodating at least one thermocouple (not shown).

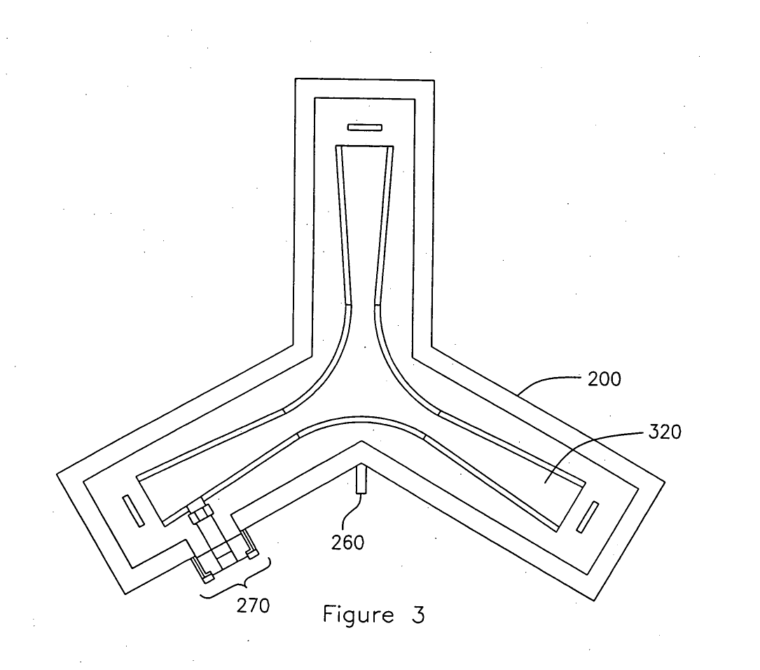

FIG. 3 illustrates, in a top view, an electroslag system 100, showing a trough 200 containing a molten metal 310, in accordance with the present invention, wherein the trough 200 may comprise a vacuum port 260 for facilitating removal of any residual gases from the molten metal 310 as well as a thermocouple bracket assembly 270 for accommodating at least one thermocouple (not shown), as discussed supra.

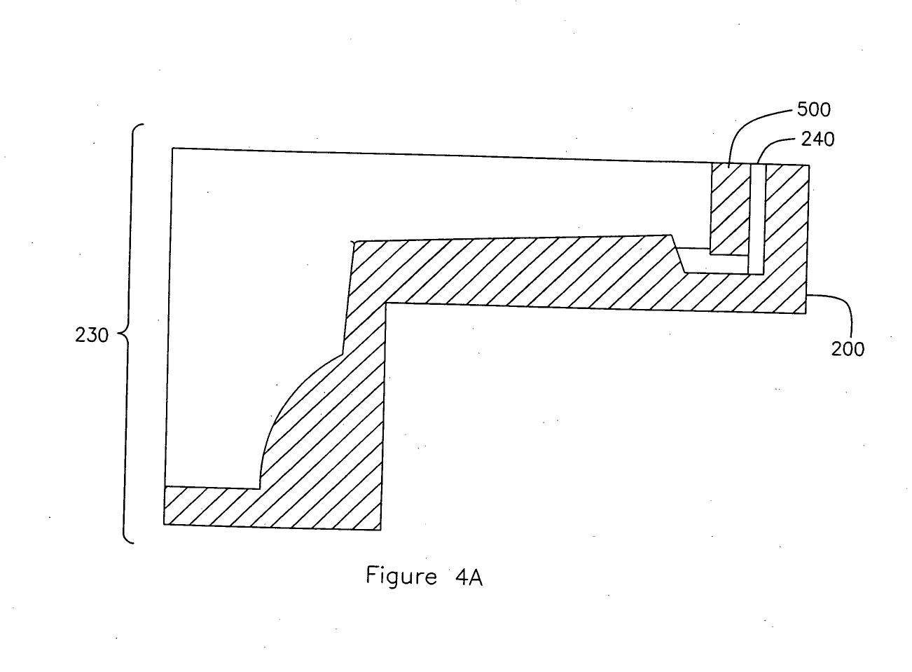

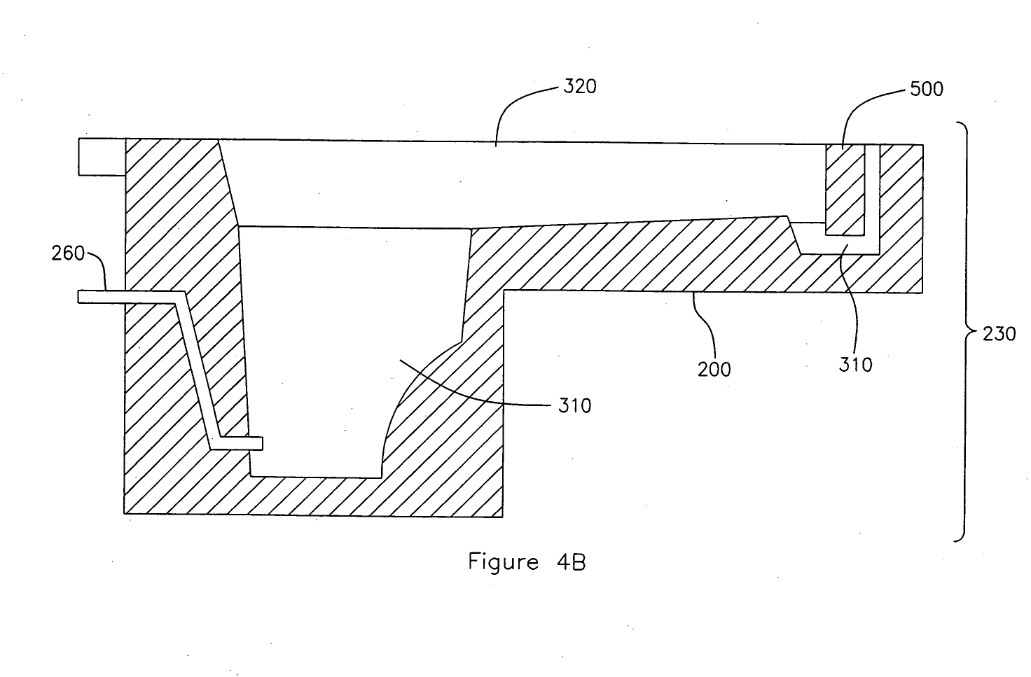

FIG. 4A illustrates, in a cross-sectional view, a smelter leg 230 of an electroslag system 100, showing a trough 200 in relation to a ceramic barrier 500, in accordance with the present invention. An opening 240 accommodates an electrode 400.

FIG. 4B illustrates, in a cross-sectional view, a smelter leg 230 of an electroslag system 100, showing a trough 200, containing a molten metal 310 and a slag 320, in relation to a ceramic barrier 500, in accordance with the present invention.

FIG. 5 illustrates, in a perspective cut-away view, a smelter leg 230 of an electroslag system 100, in accordance with the present invention. The trough 200 has an outer housing 210 and an inner liner 220. The inner liner 220 comprises a refractory material.

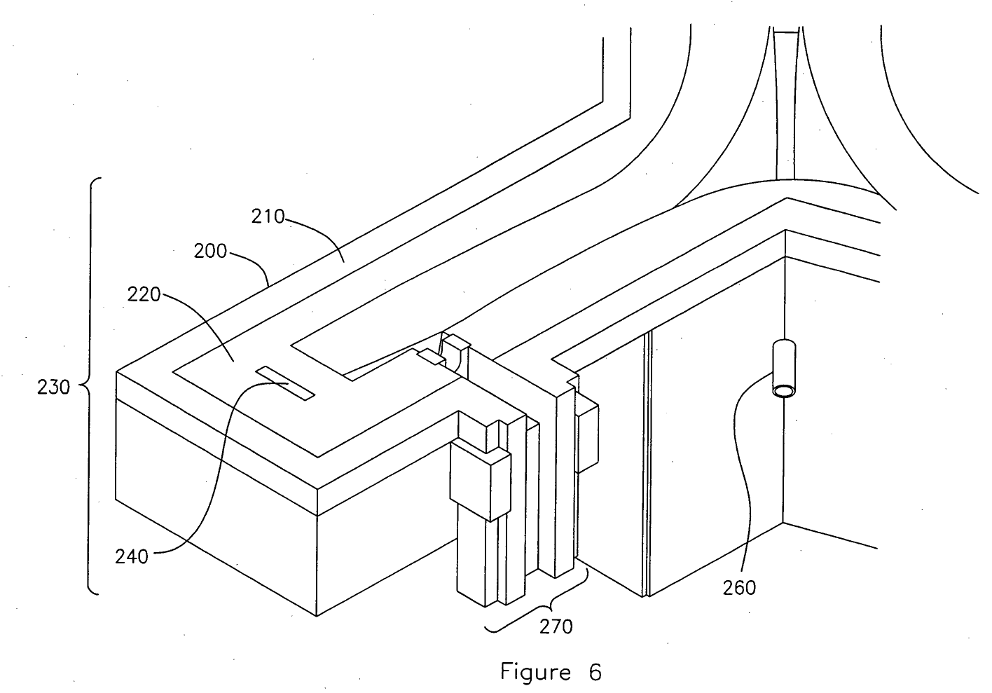

FIG. 6 illustrates, in a partial perspective view, an electroslag system 100, in accordance with the present invention, wherein the trough 200 has an outer housing 210 and an inner liner 220, as discussed, supra.

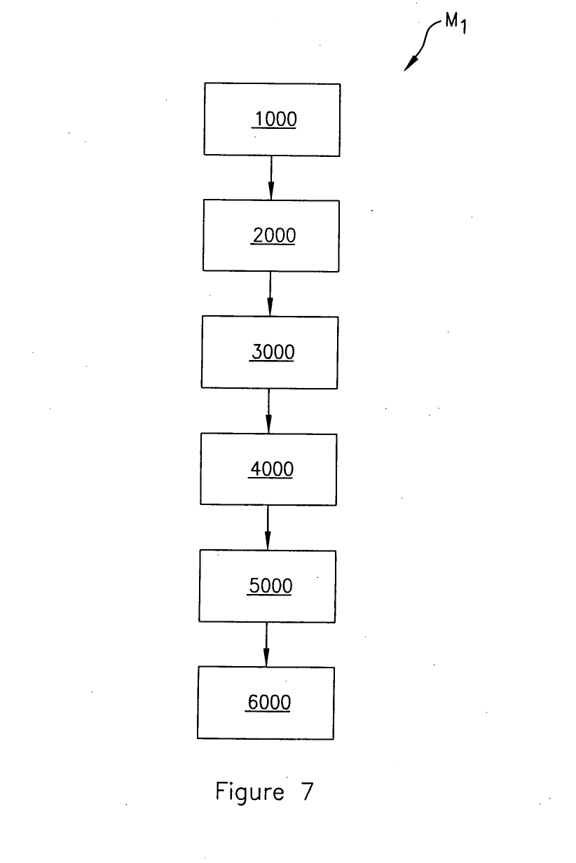

FIG. 7 illustrates, in a flowchart, a method M₁ of electroslag smelting, in accordance with the present invention. The method M₁ of electroslag smelting comprises the steps of: providing a furnace (not shown) having a wall, an internal atmosphere, and an external atmosphere, as indicated by block 1000; providing a trough 200 for accommodating an ore 300 being smelted into a molten metal 310 and a slag 320, the trough 200 being disposed within the furnace, as indicated by block 2000; providing a carbon electrode 400 having a proximal end 401 and a distal end 402, the electrode distal end 402 being disposed in the trough 200, the electrode 400 being submersible in the molten metal 310, and the electrode 400 being separated from the slag 320 by a ceramic barrier 500, as indicated by block 3000; providing a stainless steel bus bar 600 having a proximal end 601 and a distal end 602, the stainless steel bus bar distal end 602 being coupled to the electrode proximal end 401 at a position above a level of the molten metal 310, the stainless steel bus bar 600 extending through the furnace wall an into the external atmosphere, the stainless steel bus bar 600 providing mechanical stability to the electrode 400, the stainless steel bus bar 600 dissipating heat from the electrode 400, the stainless steel bus bar 600 nominally conducting heat from the furnace, as indicated by block 4000; and providing a copper bus bar 700 having a proximal end 701 and a distal end 702, the copper bus bar distal end 702 being coupled to the stainless steel bus bar proximal end 601 in the external atmosphere, and the copper bus bar 700 dissipating heat from the stainless steel bus bar 600 at a greater rate than the stainless steel bus bar 600 nominally conducting heat from the furnace, thereby effecting a thermal gradient across the stainless steel bus bar 600, the copper bus bar 700 radiating heat to the external atmosphere at a high rate, thereby minimizing corrosion of the electrode 400, and thereby effecting a low temperature equilibrium at an electrical source connection, as indicated by block 5000; and smelting the ore 300 in the furnace, thereby providing the molten metal 310 and the slag 320, the electrode 400 being submersed in the molten metal 310, and the electrode 400 being separated from the slag 320 by the ceramic barrier 500, as indicated by block 6000.

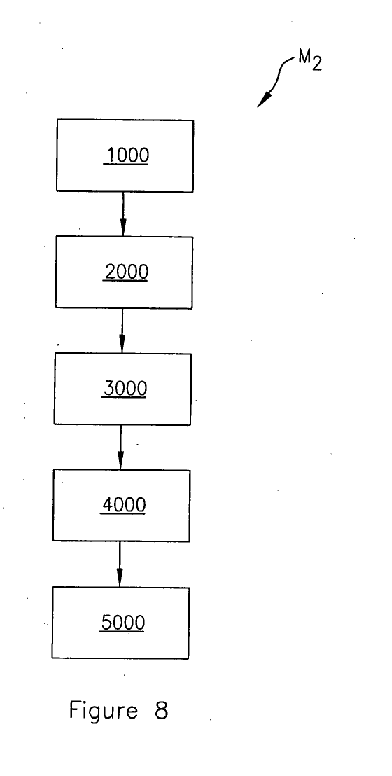

FIG. 8 illustrates, in a flowchart, a method M₂ of fabricating an electroslag smelting system 100, in accordance with the present invention. The method M₂ of fabricating an electroslag smelting system 100 comprises the steps of: providing a furnace (not shown) having a wall, an internal atmosphere, and an external atmosphere, as indicated by block 1000; providing a trough 200 for accommodating an ore 300 being smelted into a molten metal 310 and a slag 320, the trough 200 being disposed within the furnace, as indicated by block 2000; providing a carbon electrode 400 having a proximal end 401 and a distal end 402, the electrode distal end 402 being disposed in the trough 200, the electrode 400 being submersible in the molten metal 310, and the electrode 400 being separated from the slag 320 by a ceramic barrier 500, as indicated by block 3000; providing a stainless steel bus bar 600 having a proximal end 601 and a distal end 602, the stainless steel bus bar distal end 602 being coupled to the electrode proximal end 401 at a position above a level of the molten metal 310, the stainless steel bus bar 600 extending through the furnace wall an into the external atmosphere, the stainless steel bus bar 600 providing mechanical stability to the electrode 400, the stainless steel bus bar 600 dissipating heat from the electrode 400, the stainless steel bus bar 600 nominally conducting heat from the furnace, as indicated by block 4000; and providing a copper bus bar 700 having a proximal end 701 and a distal end 702, the copper bus bar distal end 702 being coupled to the stainless steel bus bar proximal end 601 in the external atmosphere, and the copper bus bar 700 dissipating heat from the stainless steel bus bar 600 at a greater rate than the stainless steel bus bar 600 nominally conducting heat from the furnace, thereby effecting a thermal gradient across the stainless steel bus bar 600, the copper bus bar 700 radiating heat to the external atmosphere at a high rate, thereby minimizing corrosion of the electrode 400, and thereby effecting a low temperature equilibrium at an electrical source connection, as indicated by block 5000.

Information as herein shown and described in detail is fully capable of attaining the above-described object of the invention, the presently preferred embodiment of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more.” All structural and functional equivalents to the elements of the above-described preferred embodiment and additional embodiments that are known to those of ordinary skill in the art are hereby expressly incorporated by reference and are intended to be encompassed by the present claims.

Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. However, that various changes and modifications in form, material, and fabrication material may be made, without departing from the spirit and scope of the inventions as set forth in the appended claims, should be readily apparent to those of ordinary skill in the art. No claim herein is to be construed under the provisions of 35 U.S.C. § 112, sixth paragraph, unless the element is expressly recited using the phrase “means for.”

### INDUSTRIAL APPLICABILITY

The present invention industrially applies to smelting systems and methods. More particularly, the present invention industrially applies to electroslag smelting systems and methods. Even more particularly, the present invention industrially applies to improvements in electroslag systems and methods.

What is claimed:

1. A system for electroslag smelting, comprising:
a furnace having a wall, an internal atmosphere, and an external atmosphere;
a trough for accommodating an ore being smelted into a molten metal and a slag, the trough being disposed within the furnace, and the trough having an outer housing and an inner liner; and
a carbon electrode having a proximal end and a distal end, the electrode distal end being disposed in the trough, the electrode being submersible in the molten metal, and the electrode being separated from the slag by a ceramic barrier.

2. A system, as recited in claim 1, further comprising a stainless steel bus bar having a proximal end and a distal end, the stainless steel bus bar distal end being coupled to the electrode proximal end at a position above a level of the molten metal, the stainless steel bus bar proximal end extending through the furnace wall and into the external atmosphere, the stainless steel bus bar providing mechanical stability to the electrode, the stainless steel bus bar dissipating heat from the electrode, and the stainless steel bus bar nominally conducting heat from the furnace.

3. A system, as recited in claim 2, further comprising a copper bus bar having a proximal end and a distal end, the copper bus bar distal end being coupled to the stainless steel bus bar proximal end in the external atmosphere, and the copper bus bar dissipating heat from the stainless steel bus bar at a greater rate than the stainless steel bus bar nominally conducting heat from the furnace.

4. A system, as recited in claim 3,
wherein a thermal gradient is effected across the stainless steel bus bar, and
wherein the copper bus bar radiates heat to the external atmosphere at a high rate.

5. A system, as recited in claim 4,
whereby a corrosion of the electrode is minimized, and
whereby a low temperature equilibrium is effected at an electrical source connection.

6. A system, as recited in claim 1, wherein the molten metal comprises lead.

7. A system, as recited in claim 1, wherein the slag comprises sodium sulfate.

8. A system, as recited in claim 1, wherein the ceramic barrier comprises a refractory material.

9. A system, as recited in claim 7, wherein the refractory material comprises aluminum oxide

10. A system, as recited in claim 1, wherein the trough comprises a vacuum port disposed therethrough for facilitating removal of any residual gases from the molten metal.

11. A system, as recited in claim 1, wherein the trough comprises a thermocouple bracket assembly for accommodating at least one thermocouple.

12. A system, as recited in claim 1, wherein the carbon electrode comprises a stainless steel foil disposed on at least one outer surface.

13. A system as recited in claim 1, further comprising:
a stainless steel bus bar having a proximal end and a distal end, the stainless steel bus bar distal end being coupled to the electrode proximal end at a position above a level of the molten metal, the stainless steel bus bar proximal end extending through the furnace wall and into the external atmosphere, the stainless steel bus bar providing mechanical stability to the electrode, the stainless steel bus bar dissipating heat from the electrode, and the stainless steel bus bar nominally conducting heat from the furnace; and
a copper bus bar having a proximal end and a distal end, the copper bus bar distal end being coupled to the stainless steel bus bar proximal end in the external atmosphere, and the copper bus bar dissipating heat from the stainless steel bus bar at a greater rate than the stainless steel bus bar nominally conducting heat from the furnace,
a thermal gradient being effected across the stainless steel bus bar, the copper bus bar radiating heat to the external atmosphere at a high rate,
a corrosion of the electrode being minimized, and
a low temperature equilibrium being effected at an electrical source connection.

14. A method of electroslag smelting, comprising the steps of:
providing a furnace having a wall, an internal atmosphere, and an external atmosphere;
providing a trough for accommodating the ore being smelted into a molten metal and a slag, the trough being disposed within the furnace, and the trough having an outer housing and an inner liner;
providing a carbon electrode having a proximal end and a distal end, the electrode distal end being disposed in the trough, the electrode being submersible in the molten metal, and the electrode being separated from the slag by a ceramic barrier; and
smelting the ore in the furnace, thereby providing a molten metal and a slag, the electrode being submersed in the molten metal, and the electrode being separated from the slag by the ceramic barrier.

15. A method, as recited in claim 14, further comprising the step of providing a stainless steel bus bar having a proximal end and a distal end, the stainless steel bus bar distal end being coupled to the electrode proximal end at a position above a level of the molten metal, the stainless steel bus bar proximal end extending through the furnace wall and into the external atmosphere, the stainless steel bus bar providing mechanical stability to the electrode, the stainless steel bus bar dissipating heat from the electrode, and the stainless steel bus bar nominally conducting heat from the furnace.

16. A method, as recited in claim 15, further comprising the step of providing a copper bus bar having a proximal end and a distal end, the copper bus bar distal end being coupled to the stainless steel bus bar proximal end in the external atmosphere, and the copper bus bar dissipating heat from the stainless steel bus bar at a greater rate than the stainless steel bus bar nominally conducting heat from the furnace.

17. A method, as recited in claim 16,
thereby effecting a thermal gradient across the stainless steel bus bar, and
thereby radiating heat via the copper bus bar to the external atmosphere at a high rate.

18. A method, as recited in claim 17,
thereby minimizing a corrosion of the electrode, and
thereby effecting a low temperature equilibrium at an electrical source connection.

19. A method, as recited in claim 14, wherein the smelting step comprises providing the molten metal with lead.

20. A method, as recited in claim 14, wherein the smelting step comprises providing the slag with sodium sulfate.

21. A method, as recited in claim 14, wherein the smelting step comprises providing the ceramic barrier with a refractory material.

22. A method, as recited in claim 20, the smelting step comprises providing the ceramic barrier with a refractory material comprising aluminum oxide.

23. A method, as recited in claim 14, wherein the trough providing step comprises providing a vacuum port disposed therethrough for facilitating removal of any residual gases from the molten metal.

24. A method, as recited in claim 14, wherein the trough providing step comprises providing a thermocouple bracket assembly for accommodating at least one thermocouple.

25. A method, as recited in claim 14, wherein the carbon electrode providing step comprises providing a stainless steel foil disposed on at least one outer surface.

26. A method, as recited in claim 14, further comprising the steps of:
providing a stainless steel bus bar having a proximal end and a distal end, the stainless steel bus bar distal end being coupled to the electrode proximal end at a position above a level of the molten metal, the stainless steel bus bar extending through the furnace wall an into the external atmosphere, the stainless steel bus bar providing mechanical stability to the electrode, the stainless steel bus bar dissipating heat from the electrode, the stainless steel bus bar nominally conducting heat from the furnace; and
providing a copper bus bar having a proximal end and a distal end, the copper bus bar distal end being coupled to the stainless steel bus bar proximal end in the external atmosphere, and the copper bus bar dissipating heat from the stainless steel bus bar at a greater rate than the stainless steel bus bar nominally conducting heat from the furnace,
thereby effecting a thermal gradient across the stainless steel bus bar, the copper bus bar radiating heat to the external atmosphere at a high rate,
thereby minimizing corrosion of the electrode, and
thereby effecting a low temperature equilibrium at an electrical source connection.

27. A method of fabricating an electroslag smelting system, comprising the steps of:
providing a furnace having a wall, an internal atmosphere, and an external atmosphere;
providing a trough for accommodating the ore being smelted into a molten metal and a slag, the trough being disposed within the furnace, and the trough having an outer housing and an inner liner;
providing a carbon electrode having a proximal end and a distal end, the electrode distal end being disposed in the trough, the electrode being submersible in the molten metal, and the electrode being separated from the slag by a ceramic barrier.

28. A method, as recited in claim 27, further comprising the step of providing a stainless steel bus bar having a proximal end and a distal end, the stainless steel bus bar distal end being coupled to the electrode proximal end at a position above a level of the molten metal, the stainless steel bus bar proximal end extending through the furnace wall and into the external atmosphere, the stainless steel bus bar providing mechanical stability to the electrode, the stainless steel bus bar dissipating heat from the electrode, and the stainless steel bus bar nominally conducting heat from the furnace.

29. A method, as recited in claim 28, further comprising the step of providing a copper bus bar having a proximal end and a distal end, the copper bus bar distal end being coupled to the stainless steel bus bar proximal end in the external atmosphere, and the copper bus bar dissipating heat from the stainless steel bus bar at a greater rate than the stainless steel bus bar nominally conducting heat from the furnace.

30. A method, as recited in claim 29,
thereby effecting a thermal gradient across the stainless steel bus bar, and
thereby radiating heat via the copper bus bar to the external atmosphere at a high rate.

31. A method, as recited in claim 30,
thereby minimizing a corrosion of the electrode, and
thereby effecting a low temperature equilibrium at an electrical source connection.

32. A method, as recited in claim 27, wherein the smelting step comprises providing the molten metal with lead.

33. A method, as recited in claim 27, wherein the smelting step comprises providing the slag with sodium sulfate.

34. A method, as recited in claim 27, wherein the smelting step comprises providing the ceramic barrier with a refractory material.

35. A method, as recited in claim 34, wherein the smelting step comprises providing the refractory material with aluminum oxide.

36. A method, as recited in claim 27, wherein the trough providing step comprises providing a vacuum port disposed therethrough for facilitating removal of any residual gases from the molten metal.

37. A method, as recited in claim 27, wherein the trough providing step comprises providing a thermocouple bracket assembly for accommodating at least one thermocouple.

38. A method, as recited in claim 27, wherein the carbon electrode providing step comprises providing a stainless steel foil disposed on at least one outer surface.

39. A method, as recited in claim 27, further comprising the steps of:
providing a stainless steel bus bar having a proximal end and a distal end, the stainless steel bus bar distal end being coupled to the electrode proximal end at a position above a level of the molten metal, the stainless steel bus bar extending through the furnace wall an into the external atmosphere, the stainless steel bus bar providing mechanical stability to the electrode, the stainless steel bus bar dissipating heat from the electrode, the stainless steel bus bar nominally conducting heat from the furnace; and
providing a copper bus bar having a proximal end and a distal end, the copper bus bar distal end being coupled to the stainless steel bus bar proximal end in the external atmosphere, and the copper bus bar dissipating heat from the stainless steel bus bar at a greater rate than the stainless steel bus bar nominally conducting heat from the furnace,
thereby effecting a thermal gradient across the stainless steel bus bar, the copper bus bar radiating heat to the external atmosphere at a high rate,
thereby minimizing corrosion of the electrode, and
thereby effecting a low temperature equilibrium at an electrical source connection.
